(19) United States
(12) Patent Application Publication
(10) Pub. No.: US 2009/0197148 A1
(43) Pub. Date: Aug. 6, 2009

(54) ELECTRIC POWER GENERATING ELEMENT, FUEL CELL UNIT, AND FUEL CELL STACK

(75) Inventors: Kenji Sato, Toyota-shi (JP); Fumishige Shizuku, Komaki-shi (JP)

Correspondence Address: GIFFORD, KRASS, SPRINKLE,ANDERSON & CITKOWSKI, P.C, PO BOX 7021, TROY, MI, 48007-7021, US

(73) Assignee: Toyota Jidosha Kabushiki Kaisha, Aichi-Ken (JP)

(21) Appl. No.: 12/366,691

(22) Filed: Feb. 6, 2009

(30) Foreign Application Priority Data
Feb. 6, 2008 (JP) JP2008-026512

(51) Int. Cl. H01M 2/08

(52) U.S. Cl. 429/35

(57) ABSTRACT

An electric power generating element that generates electric power using reactant gas supplied thereto includes: an electrolyte portion; a reactant gas flow field that supplies the reactant gas to the electrolyte portion; a surrounding seal member that surrounds an outer periphery of the reactant gas flow field; and a bypass flow suppressing portion that suppresses a bypass flow, which is a flow of the reactant gas between the outer periphery of the reactant gas flow field and the surrounding seal member.

### INCORPORATION BY REFERENCE

The disclosure of Japanese Patent Application No. 2008-026512 filed on Feb. 6, 2008 including the specification, drawings and abstract is incorporated herein by reference in its entirety.

### BACKGROUND OF THE INVENTION

1. Field of the Invention

The invention relates to an electric power generating element, a fuel cell unit, and a fuel cell stack.

2. Description of the Related Art

In a related art, there has been suggested a fuel cell stack that is formed of alternately stacked electric power generating elements and separators. Each electric power generating element has an electrolyte and a reactant gas flow field that supplies reactant gas to the electrolyte. Each separator supplies reactant gas to the electric power generating element and collects electric current. In the above stacked structure, in order to suppress reactant gas leakage when the reactant gas is supplied to the electric power generating element, a seal structure is generally provided so that a gasket is held between the electric power generating element and the separator. The gasket has a seal line formed to suppress leakage of reactant gas or refrigerant to another system or to the outside.

On the other hand, in recent years, there has been disclosed a technique for increasing the efficiency at which reactant gas is supplied to the electrolyte within the same system (for example, inside a fuel gas system). For example, Japanese Patent Application Publication No. 2007-250351 (JP-A-2007-250351) describes a technique that reduces the porosity of a porous reactant gas flow field at the outer peripheral portion thereof to suppress a bypass flow (or a short circuit flow) inside the seal line. The “bypass flow” means that reactant gas supplied to the reactant gas flow field leaks from the reactant gas flow field, bypasses the electrolyte (shorts) and flows to the downstream side without contributing to a supply to the electrolyte.

However, in the above related art, suppressing the bypass flow by methods other than the reactant gas flow field has not been sufficiently considered.

### SUMMARY OF THE INVENTION

The invention provides a technique for increasing the efficiency at which reactant gas is supplied to an electrolyte in a fuel cell that generates electric power using reactant gas supplied thereto.

An aspect of the invention provides an electric power generating element that generates electric power using reactant gas supplied thereto. The electric power generating element includes: an electrolyte portion; a reactant gas flow field that supplies the reactant gas to the electrolyte portion; a surrounding seal member that surrounds an outer periphery of the reactant gas flow field; and a bypass flow suppressing portion that suppresses a bypass flow, which is a flow of the reactant gas between the outer periphery of the reactant gas flow field and the surrounding seal member.

With the above structure, the bypass flow, which is a flow of the reactant gas between the outer periphery of the reactant gas flow field and the surrounding seal member, is suppressed. Thus, it is possible to improve the efficiency at which reactant gas is supplied from the reactant gas flow field to the electrolyte portion. In addition, the bypass flow of the reactant gas is suppressed outside the reactant gas flow field. Thus, there are no restrictions on the material or structure of the reactant gas flow field.

In the electric power generating element according to the above aspect, the bypass flow suppressing portion may have a linear seal member that extends from the surrounding seal member toward the outer periphery of the reactant gas flow field.

With the above structure, it is possible to reduce a contact pressure decreasing region between the electric power generating element and the separator, caused by adding the seal member, and also it is possible to effectively suppress the bypass flow of the reactant gas between the reactant gas flow field and the surrounding seal member.

In the electric power generating element according to the above aspect, a plurality of the linear seal members may be provided. With the above structure, it is possible to generate a contact pressure of the linear seal members without excessively increasing a reaction force to a plate.

In the electric power generating element according to the above aspect, the linear seal member may connect the surrounding seal member to the outer periphery of the reactant gas flow field.

In the electric power generating element according to the above aspect, the linear seal member may have a shape by which a gap between the outer periphery of the reactant gas flow field and the surrounding seal member is closed or reduced so as to facilitate a decrease in pressure of reactant gas that flows in the gap.

In the electric power generating element according to the above aspect, the linear seal member may extend from the surrounding seal member across the outer periphery of the reactant gas flow field to an inside of the outer periphery.

With the above structure, it is possible to further effectively suppress the bypass flow of the reactant gas that flows between the reactant gas flow field and the surrounding seal member.

In the electric power generating element according to the above aspect, a squeeze of the linear seal member may be smaller than or equal to a squeeze of the surrounding seal member.

The linear seal member suppresses reactant gas leakage in order to improve the efficiency inside a reactant gas supply system, while, on the other hand, the surrounding seal member suppresses reactant gas leakage from the reactant gas supply system. Thus, the surrounding seal member plays a more important role than the linear seal member does. In this way, the surrounding seal member and the linear seal member differ in the importance of sealing from each other. With the above structure, it is possible to implement sealing performance based on the importance of sealing in such a manner that the squeeze is varied on the basis of the importance of sealing and the squeeze of the linear seal member is relatively reduced.

In the electric power generating element according to the above aspect, the surrounding seal member may intersect with the linear seal member at an intersection, and at the intersection, the squeeze of the surrounding seal member may be equal to the squeeze of the linear seal member.

In the electric power generating element according to the above aspect, the linear seal member may have a shape such that a squeeze adjacent to the reactant gas flow field is smaller than a squeeze adjacent to the surrounding seal member.

At the side adjacent to the reactant gas flow field, in terms of the efficiency at which electric current is collected to the separator, it is desired to maintain a certain contact pressure between the separator and the reactant gas flow field. However, when the squeeze of the linear seal member increases, it is likely that a reaction force concentrates on the linear seal member and, as a result, a peripheral contact pressure decreases. With the above described structure, the linear seal member has a shape such that the squeeze adjacent to the reactant gas flow field is smaller than the squeeze adjacent to the surrounding seal member to thereby eliminate the above problem.

In the electric power generating element according to the above aspect, the linear seal member may have a shape such that a squeeze of the linear seal member is continuously reduced from a side adjacent to the surrounding seal member toward a side adjacent to the reactant gas flow field.

With the above structure, a decrease in contact pressure near the reactant gas flow field is suppressed to make it possible to reduce a decrease in the efficiency at which electric current is collected to the separator.

In the electric power generating element according to the above aspect, the linear seal member may be arranged between a region, in which the reactant gas flow field is supplied with the reactant gas, and a region, in which the reactant gas flow field discharges the reactant gas, in a direction in which the reactant gas flows in the reactant gas flow field.

The pressure of reactant gas is high in the region in which the reactant gas flow field is supplied with the reactant gas, whereas the pressure of reactant gas is low in the region in which the reactant gas flow field discharges the reactant gas. Thus, there easily occurs a pressure difference between the regions. This pressure difference is a major cause of occurrence of a bypass flow. With the above described structure, the linear seal member is provided between the regions. Thus, it is possible to effectively suppress the bypass flow.

In the electric power generating element according to the above aspect, the linear seal member may have a straight line shape.

In the electric power generating element according to the above aspect, a direction in which the linear seal member extends from the surrounding seal member toward the outer periphery of the reactant gas flow field may intersect with a direction in which the reactant gas flows in the reactant gas flow field.

In the electric power generating element according to the above aspect, the bypass flow may be a flow of the reactant gas other than the reactant gas that flows within the reactant gas flow field.

A fuel cell unit may include: the electric power generating element according to the above aspect; and a separator that is connected to the electric power generating element and that has a channel through which the reactant gas is supplied to the electric power generating element.

A fuel cell stack may include: the electric power generating element according to the above aspect; and a separator that has a channel through which the reactant gas is supplied to the electric power generating element, and the electric power generating element and the separator may be alternately stacked.

In the fuel cell stack, the electric power generating element and the separator may be integrated.

A fuel cell stack may include: the electric power generating element according to the above aspect; and a separator, and the plurality of the linear seal members may be provided on both sides of the electric power generating element respectively and arranged so as to overlap as viewed in a direction in which the electric power generating element and the separator are stacked with respect to one another.

In the fuel cell stack, the squeeze of the linear seal member and the squeeze of the surrounding seal member may be measured in a direction in which the electric power generating element and the separator are stacked.

### BRIEF DESCRIPTION OF THE DRAWINGS

The features, advantages, and technical and industrial significance of this invention will be described in the following detailed description of example embodiments of the invention with reference to the accompanying drawings, in which like numerals denote like elements, and wherein:

FIG. 1 is an exploded perspective view that illustrates the schematic structure of a fuel cell stack according to the related art;

FIG. 2 is a cross-sectional view, taken along the line II-II in FIG. 1, of the fuel cell stack according to the related art;

FIG. 3 is a cross-sectional view, taken along the line III-III in FIG. 1, of the fuel cell stack according to the related art;

FIG. 4A is an exploded perspective view that illustrates the structure of an electric power generating element according to the related art, and FIG. 4B is a perspective view that illustrates the structure of the electric power generating element according to the related art;

FIG. 5 is a cross-sectional view, taken along the line V-V in FIG. 4B, of the electric power generating element according to the related art;

FIG. 6 is a view that illustrates a state where a bypass flow occurs between the electric power generating element and a separator as viewed in a direction indicated by an arrow D in FIG. 5 according to the related art;

FIG. 7 is a view that illustrates a seal line designed on the basis of the related art as viewed in the direction indicated by the arrow D in FIG. 5;

FIG. 8 is a cross-sectional view taken along the line V-V in FIG. 4B, illustrating the seal line designed on the basis of the related art;

FIG. 9 is a view that illustrates a problem of the seal line designed on the basis of the related art as viewed in the direction indicated by the arrow D in FIG. 5;

FIG. 10 is a view that illustrates a seal line designed on the basis of an embodiment as viewed in the direction indicated by the arrow D in FIG. 5;

FIG. 11 is a cross-sectional view, taken along the line XI-XI in FIG. 10, of seal members according to the embodiment as viewed from another angle;

FIG. 12 is a view that shows a seal member according to a first alternative embodiment to the embodiment as viewed in the direction indicated by the arrow D in FIG. 5; and

FIG. 13 is a cross-sectional view, taken along the line V-V in FIG. 5, illustrating an integrated structure according to a second alternative embodiment to the embodiment.

### DETAILED DESCRIPTION OF EMBODIMENTS

Hereinafter, an embodiment of the invention will be described. Note that in the description of the embodiment, like reference numerals denote like components to those of a comparative embodiment, and the description thereof is omitted where appropriate.

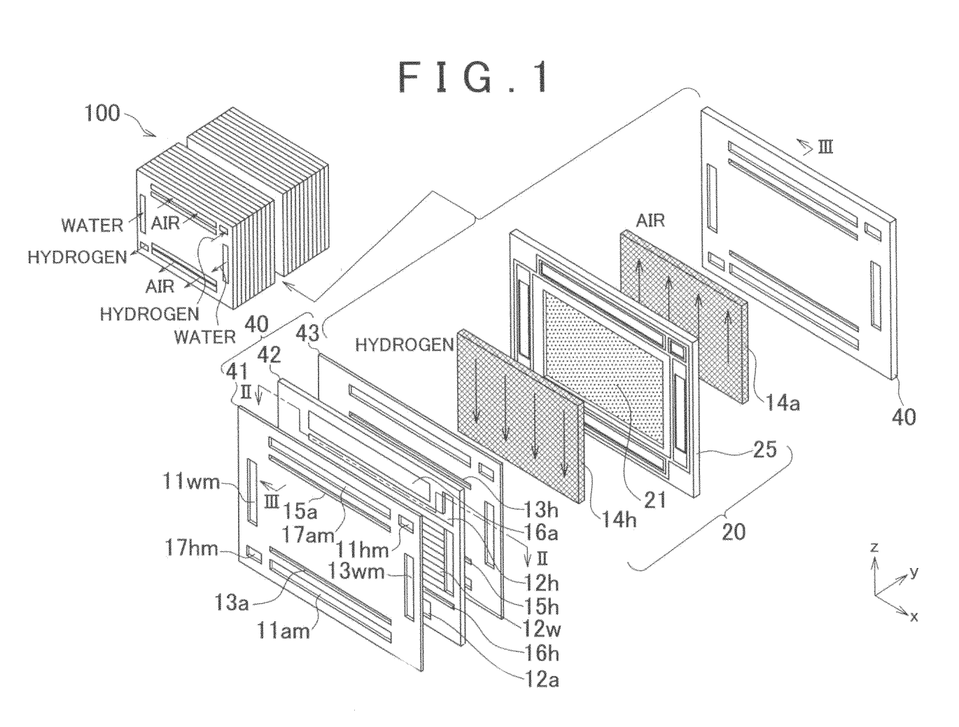

FIG. 1 is an exploded perspective view that illustrates the schematic structure of a fuel cell stack 100 according to the comparative embodiment. The comparative embodiment and the embodiment, which will be described later, will be described by taking a solid polymer fuel cell as an example. In the comparative embodiment, the fuel cell stack 100 is formed so that an electric power generating element 20 and a separator 40 are alternately stacked and held from both ends thereof by a terminal, an insulator, and an end plate (which are not shown).

Each electric power generating element 20 includes an electrolyte portion 25, a hydrogen electrode-side porous flow field 14h and an air electrode-side porous flow field 14a. The electrolyte portion 25 has a membrane electrode assembly 21 that generates electric power using reactant gas supplied thereto by electrochemical reaction. The hydrogen electrode-side porous flow field 14h supplies hydrogen gas to the membrane electrode assembly 21. The air electrode-side porous flow field 14a supplies air, which serves as oxidant gas, to the membrane electrode assembly 21.

The hydrogen electrode-side porous flow field 14h and the air electrode-side porous flow field 14a each serve as a flow field for reactant gas (fuel gas containing hydrogen or oxidant gas containing air) subjected to the electrochemical reaction in the membrane electrode assembly 21 and also collect electric current. In each reactant gas flow field (the hydrogen electrode-side porous flow field 14h and the air electrode-side porous flow field 14a), reactant gas flows in a Z-axis direction in FIG. 1. The porous flow fields 14h and 14a may be generally made of a conductive member that is permeable to gas, such as a carbon paper, a carbon cloth, and a carbon nanotube. In addition, an expanded metal or a press material, which will be described later, may also be used.

Each separator 40 forms the wall surface of the porous flow field 14h or 14a, which serve as a flow field for reactant gas. The separator 40 may be made of a various conductive member that is nonpermeable to reactant gas, such as a dense carbon, for which carbon is compressed to be nonpermeable to gas, a fired carbon, and a stainless steel. In the comparative embodiment, each separator 40 is formed as a three-layer separator that includes a cathode plate 41, an anode plate 43 and an intermediate plate 42. The cathode plate 41 is in contact with the air electrode-side porous flow field 14a. The anode plate 43 is in contact with the hydrogen electrode-side porous flow field 14h. The intermediate plate 42 is arranged between the cathode plate 41 and the anode plate 43.

The internal channel of the fuel cell stack 100 includes a fuel gas channel through which fuel gas flows, an air channel through which air flows, and a coolant channel through which coolant flows. These channels will be described with reference to the cross-sectional views of the fuel cell stack 100, respectively taken along the line II-II in FIG. 1 and the line III-III in FIG. 1.

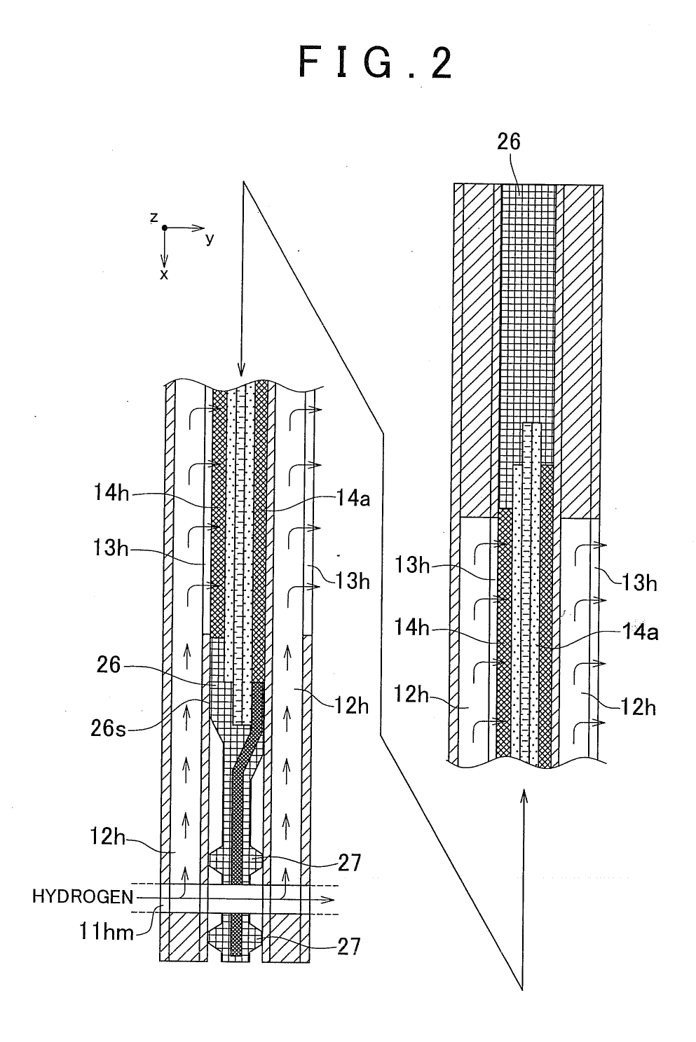

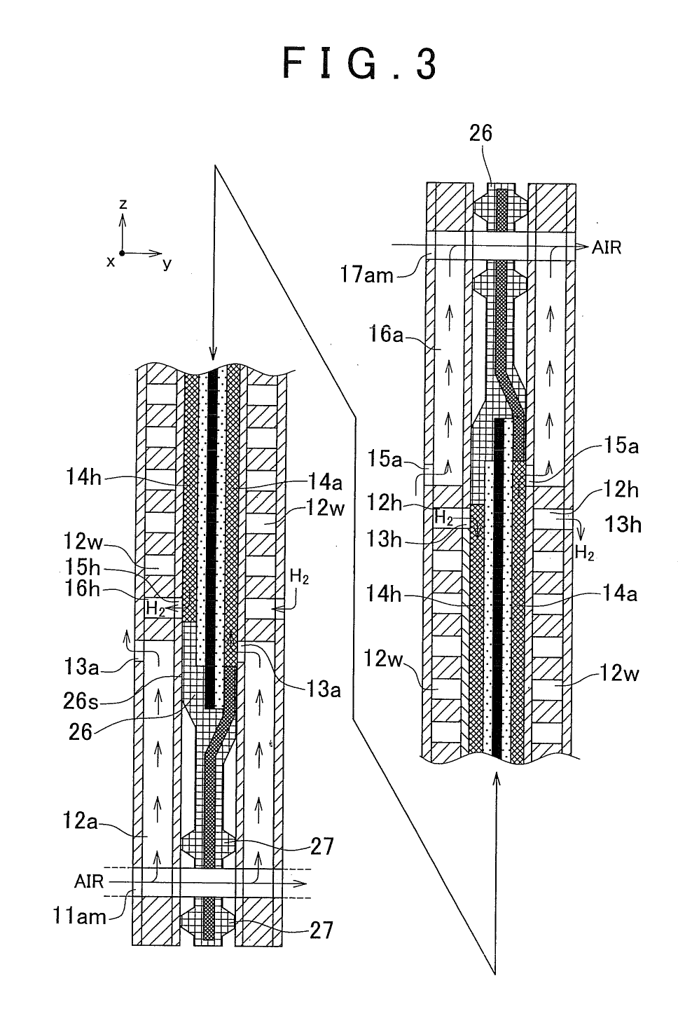

FIG. 2 is a view that illustrates the cross-sectional view, taken along the line II-II in FIG. 1, of the fuel cell stack 100 according to the comparative embodiment. FIG. 2 shows a channel for supplying hydrogen gas, which serves as fuel gas, to the porous flow field 14h. FIG. 3 is the cross-sectional view, taken along the line III-III in FIG. 1, of the fuel cell stack 100 according to the comparative embodiment. FIG. 3 shows a channel for discharging hydrogen gas from the porous flow field 14h, the entire air channel through which air serving as oxidant gas flows, and the coolant channel.

The coolant channel includes a coolant supply manifold 11wm (FIG. 1), a coolant supply channel 12w (FIG. 1 and FIG. 3) and a coolant discharge manifold 13wm (FIG. 1). Coolant flows in the stated order.

The fuel gas channel includes a fuel gas supply manifold 11hm (FIG. 1 and FIG. 2), a fuel gas flow field 12h (FIG. 1, FIG. 2 and FIG. 3), a fuel gas supply hole 13h (FIG. 1, FIG. 2 and FIG. 3), the hydrogen electrode-side porous flow field 14h (FIG. 1, FIG. 2 and FIG. 3), a fuel gas discharge hole 15h (FIG. 1 and FIG. 3), a fuel gas discharge channel 16h (FIG. 1 and FIG. 3), and a fuel gas discharge manifold 17hm (FIG. 1). Fuel gas flows in the stated order. Note that the fuel gas discharge channel 16h has a shape that is point-symmetrical to the fuel gas flow field 12h so that portion of the fuel gas discharge channel 16h is in fluid communication with the fuel gas discharge manifold 17hm.

The air channel includes an air supply manifold 11am (FIG. 1 and FIG. 3), an air supply channel 12a (FIG. 1 and FIG. 3), an air supply hole 13a (FIG. 1 and FIG. 3), the air electrode-side porous flow field 14a (FIG. 1 and FIG. 3), an air discharge hole 15a (FIG. 1 and FIG. 3), an air discharge channel 16a (FIG. 1), and an air discharge manifold 17am (FIG. 1). Air flows in the stated order.

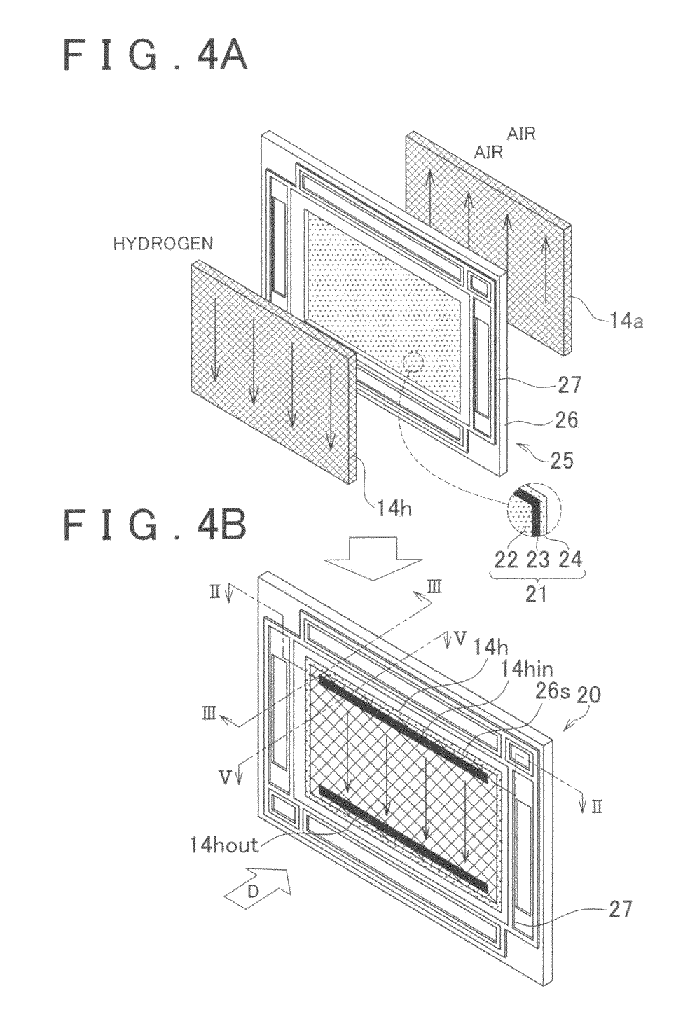

FIG. 4A is an exploded perspective view that illustrates the structure of the electric power generating element according to the comparative embodiment. FIG. 4B is a perspective view that illustrates the structure of the electric power generating element according to the comparative embodiment; The electric power generating element 20 includes the hydrogen electrode-side porous flow field 14h, the air electrode-side porous flow field 14a and the electrolyte portion 25, as described above. The electrolyte portion 25 has seal members 27 and a frame portion 26. The frame portion 26 provides rigidity to the membrane electrode assembly 21 and is integrated with the seal members 27.

The membrane electrode assembly 21 is a portion at which electrochemical reaction is performed in the fuel cell as described above. The membrane electrode assembly 21 includes a hydrogen electrode-side electrode layer 22, an electrolyte membrane 23, and an air electrode-side electrode layer 24. The electrolyte membrane 23 has a proton-conducting ion-exchange membrane made of a solid polymer material. The hydrogen electrode-side electrode layer 22 and the air electrode-side electrode layer 24 each are formed so that a catalyst is supported on a conductive carrier.

The frame portion 26 has recesses on both sides of the membrane electrode assembly 21 so that the hydrogen electrode-side porous flow field 14h and the air electrode-side porous flow field 14a are respectively fitted in the recesses. Thus, when the hydrogen electrode-side porous flow field 14h and the air electrode-side porous flow field 14a are fitted to the frame portion 26, each surface of the fitted flow field 14h and 14a is substantially flush with a region 26s (FIG. 2 and FIG. 3). With the above structure, the fitted flow field 14h or 14a is airtightly sealed to some extent in such a manner that the region 26s is in pressing contact with the separator 40 (FIG. 1 and FIG. 3).

However, the pressing contact between the region 26s and the separator 40 is performed at a low contact pressure in consideration of maintaining a current collecting effect by maintaining a contact pressure between the separator 40 and the hydrogen electrode-side porous flow field 14h, or the like, so a certain amount of leakage is assumed in advance. Thus, the hydrogen electrode-side porous flow field 14h is sealed by the seal member 27 provided on the frame portion 26.

Supply of reactant gas to the hydrogen electrode-side porous flow field 14h is carried out from the fuel gas supply hole 13h (FIG. 1 and FIG. 2) to a reactant gas supply region 14hin (solid region at the upper side in FIG. 4B) of the hydrogen electrode-side porous flow field 14h. Discharge of reactant gas is carried out from a reactant gas discharge region 14hout (solid region at the lower side in FIG. 4B) of the hydrogen electrode-side porous flow field 14h to the fuel gas discharge hole 15h (FIG. 1 and FIG. 3).

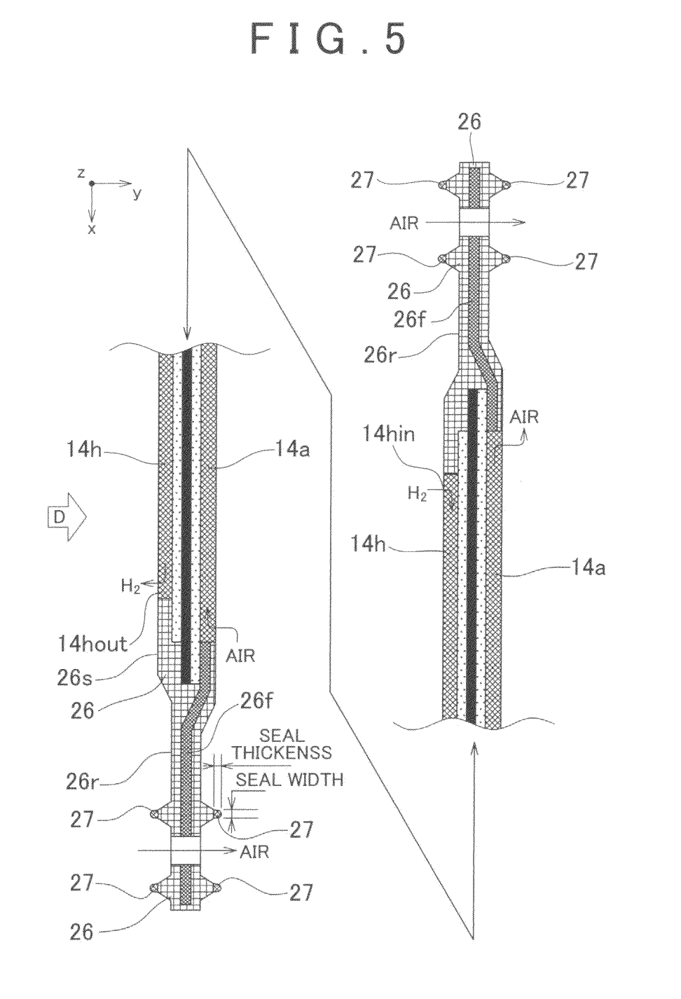

FIG. 5 is a cross-sectional view, taken along the like V-V in FIG. 4B, of the electric power generating element 20 according to the comparative embodiment. The electric power generating element 20 has the seal members 27 on the frame portion 26. The seal members 27 are formed by bonding the elastic seal members to the frame portion 26. The seal members 27 are provided on a connected surface between the electric power generating element 20 and the separators 40 in order to prevent leakage among the fuel gas channel, oxidant gas channel and coolant channel and leakage from the channels to the outside. In addition, the frame portion 26 has an internal frame 26f inside for ensuring rigidity at the end portion thereof.

The above description of the structure of the comparative embodiment may also apply to the structure of the embodiment, which will be described later.

The seal thickness and seal width of the seal member 27 are determined so as to satisfy predetermined leakage-proof performance. When the seal thickness is, for example, increased, a “squeeze” when stacked increases to enhance leakage-proof performance, whereas it causes a resistance to increase when stacked. When the resistance increases when stacked, a fastening load also problematically increases when stacked. When the seal width is, for example, reduced, a contact pressure increases to enhance leakage-proof performance, whereas it is likely to cause falling or buckling. Thus, the seal thickness and seal width of the seal member 27 are determined in terms of the above points, so the narrow seal line as shown in FIG. 4 and FIG. 5 is set.

Furthermore, the arrangement of the seal members 27 on the frame portion 26 and the cross-sectional shape of the frame portion 26 near the seal members 27 are also determined in consideration of leakage-proof performance. For example, in order to concentrate stress on the seal members 27, the thickness of the frame portion 26 in the stacking direction near the seal members 27 is reduced and, therefore, recesses 26r are formed. In addition, a predetermined distance is provided in an X-axis direction between the seal member 27 and the hydrogen electrode-side porous flow field 14h to suppress a situation that a contact pressure between the hydrogen electrode-side porous flow field 14h and the separator 40 decreases due to a resistance from the seal member 27 and, as a result, a decrease in current collecting effect occurs due to the decrease in contact pressure.

However, the thus designed seal line between the electric power generating elements 20 and the separators 40 achieve the design purpose for preventing leakage among the systems and leakage from the systems to the outside, whereas, in terms of supply of reactant gas from the hydrogen electrode-side porous flow field 14h to the membrane electrode assembly 21, a decrease in efficiency occurs due to a “bypass flow”.

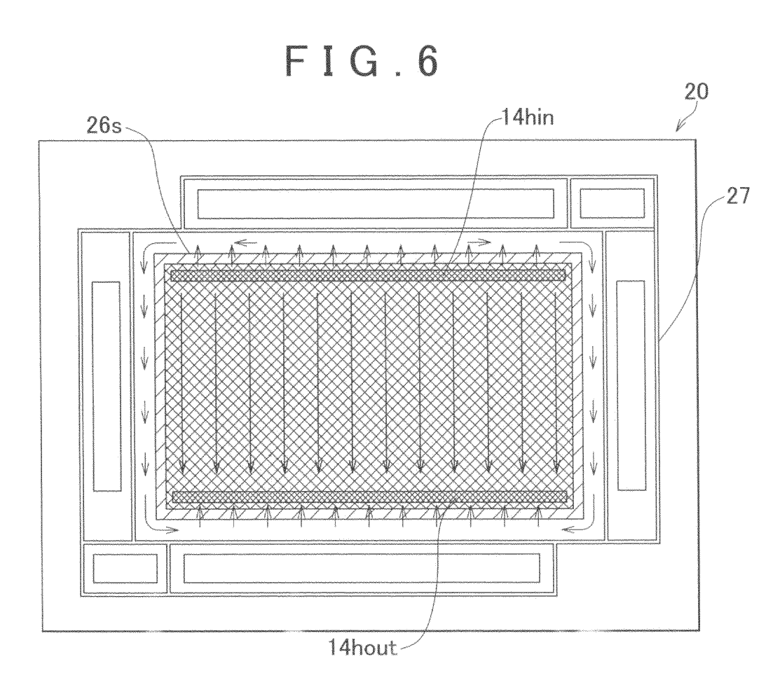

FIG. 6 is a view that illustrates a state where the bypass flow occurs between the electric power generating element 20 and the separator 40 as viewed in a direction indicated by an arrow D in FIG. 5 according to the comparative embodiment. In terms of design, hydrogen gas supplied from the reactant gas supply region 14hin passes through the inside of the hydrogen electrode-side porous flow field 14h and is then discharged from the reactant gas discharge region 14hout; however, it has been found that portion of hydrogen gas supplied from the reactant gas supply region 14hin passes through a gap formed by the recess 26r (FIG. 5) and then reaches the reactant gas discharge region 14hout. The above unexpected flow is termed “bypass flow” in the specification.

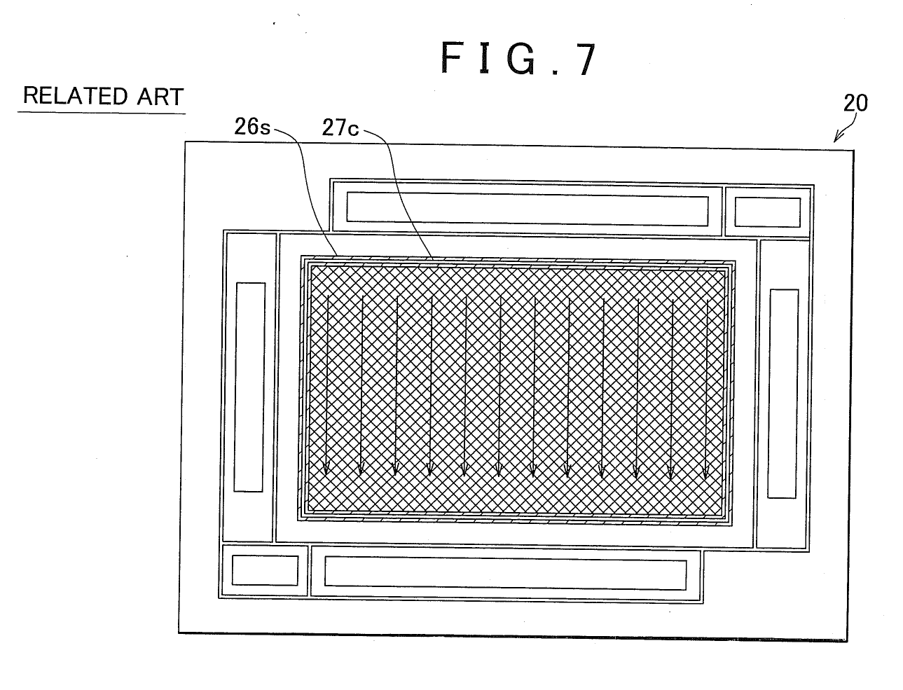

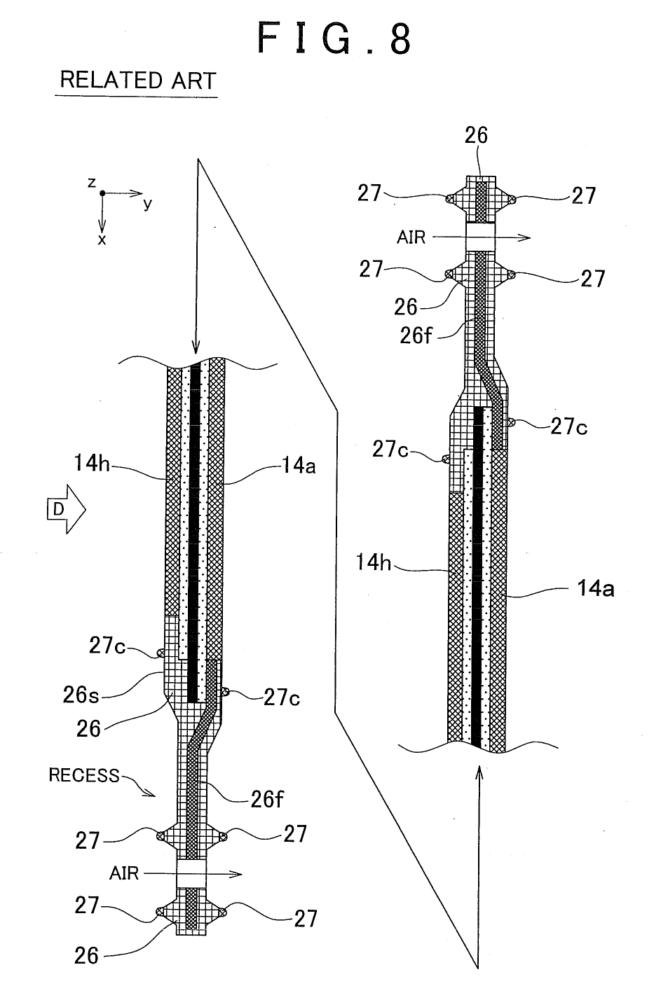

FIG. 7 is a view that illustrates the seal line designed on the basis of the related art as viewed in the direction indicated by the arrow D in FIG. 5. FIG. 8 is a cross-sectional view taken along the line V-V in FIG. 4B, illustrating the seal line designed on the basis of the related art. This seal line provides a seal member 27c in order to prevent leakage from the hydrogen electrode-side porous flow field 14h to the gap (formed by the recess 26r). This seal line is designed on the basis of a similar design concept to that of the other seal line, so it has a closed shape for enclosing hydrogen gas. However, it has also been realized that the above general seal design produces the following problem.

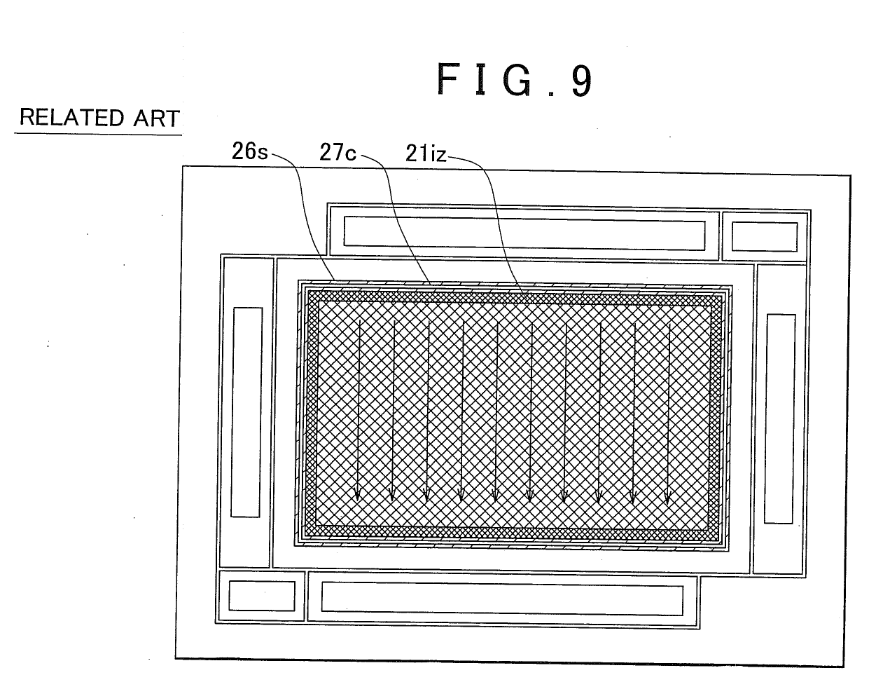

FIG. 9 is a view that illustrates a problem of the seal line designed on the basis of the related art as viewed in the direction indicated by the arrow D in FIG. 5. It has been found from the analysis conducted by the inventors that sealing by the seal member 27c raises a problem that a contact pressure excessively decreases due to a resistance from the seal member 27c in a region 21iz (contact pressure decreasing region) at the outer side of the hydrogen electrode-side porous flow field 14h, that is, near the seal member 27c. In addition, it has also been found that the resistance from the seal member 27c forms a new gap on the inner side of the seal member 27c, and this may cause a new bypass flow. In this way, it has been realized that the technique of a general seal design cannot eliminate the problem.

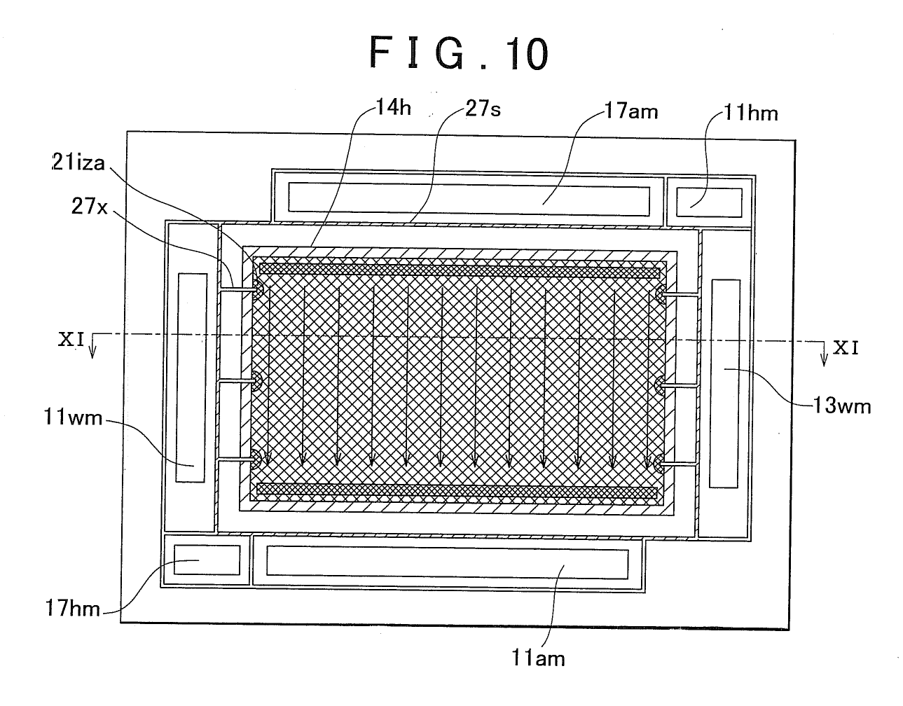

FIG. 10 is a view that illustrates a seal line according to the present embodiment as viewed in the direction indicated by the arrow D in FIG. 5. In the related art, the channels, such as the air supply manifolds 11am, the air discharge manifold 17am, the fuel gas supply manifolds 11hm, the fuel gas discharge manifold 17hm, the coolant supply manifolds 11wm and the coolant discharge manifold 13wm are sealed by the closed seal line, formed of the seal member 27, that surrounds the channels. Furthermore, the outer periphery of the hydrogen electrode-side porous flow field 14h is sealed by a specific portion 27s (hatched portion) of the seal member 27. The specific portion 27s may be regarded as an example of “surrounding seal member” according to the aspects of the invention.

In contrast to the above related art, seal members 27x according to the present embodiment are formed as open linear seal members on purpose. For the above linear seal members 27x, some measures need to be taken for their terminal ends in the related art. However, the inventors of the application have found that this does not become a large problem in terms of the following two reasons. The first reason is that the linear seal members are not intended to prevent leakage to another system or to the outside but to increase the efficiency, so complete sealing is not required. The second reason is that, in order to suppress the bypass flow without sticking to complete sealing between the recess 26r and the hydrogen electrode-side porous flow field 14h, it is only necessary to reduce a pressure difference between the recess 26r and the hydrogen electrode-side porous flow field 14h, and this reduction in the pressure difference is achieved by dividing the gap formed of the recess 26r with a “highly resistant” structure.

With the above structure, contact pressure decreasing regions 21iza (FIG. 10) are just partially formed at the outer periphery of the hydrogen electrode-side porous flow field 14h (FIG. 10). Thus, it is possible to suppress a decrease in the efficiency as compared with the contact pressure decreasing region 21iz (FIG. 9) that arises all over the outer periphery in the comparative embodiment. Hence, it appears that it is possible to suppress a decrease in contact pressure of the hydrogen electrode-side porous flow field 14h while suppressing the bypass flow.

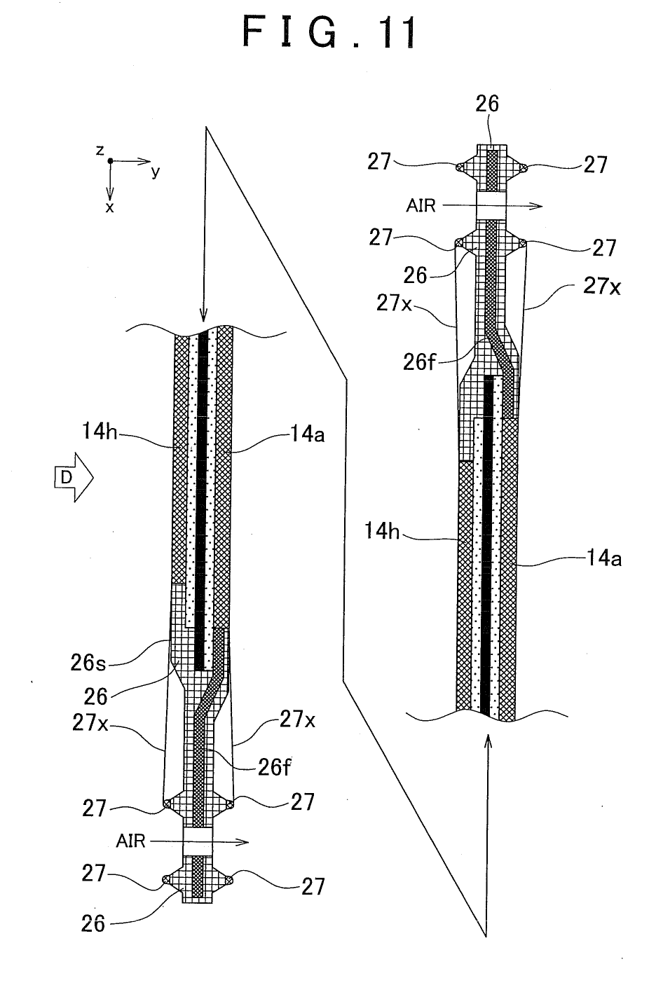

FIG. 11 is a cross-sectional view, taken along the line XI-XI in FIG. 10, of the seal members 27x according to the present embodiment as viewed from another angle. As is apparent from FIG. 11, in the present embodiment, the seal members 27x are also provided for the air electrode-side porous flow field 14a. Here, the seal members 27x are arranged on both sides of the frame portion 26 at locations at which the seal members 27x support each other, that is, the seal members 27x are arranged so as to overlap each other as viewed in the stacking direction of the frame portion 26 to thereby allow a sufficient contact pressure to be applied to the seal members 27x.

In this way, in the structure that the seal members 27x support each other on both sides of the frame portion 26, the linear seal members 27x each have a straight line shape. This is because, when the linear seal members 27x have a straight line shape, it is possible to easily form a structure even in the structure that the location of the end portion of the hydrogen electrode-side porous flow field 14h does not coincide with the location of the end portion of the air electrode-side porous flow field 14a. The structure that both end portions do not coincide with each other is advantageous in that it is possible to effectively suppress leakage between the hydrogen electrode-side porous flow field 14h and the air electrode-side porous flow field 14a at their terminal ends.

Furthermore, as is apparent from FIG. 11, each of the seal members 27x is formed so that the level in the stacking direction (Y-axis direction) varies. Specifically, the level of the seal member 27x is higher as it gets close to the seal member 27 that surrounds the outer periphery of the hydrogen electrode-side porous flow field 14h, while the level of the seal member 27x is lower as it gets close to the hydrogen electrode-side porous flow field 14h. This shape is a new structure created by the inventors of the application. This shape provides an additional advantage that a decrease in contact pressure near the hydrogen electrode-side porous flow field 14h is further suppressed to make it possible to reduce a decrease in the efficiency at which electric current is collected to the separator 40.

In this way, in the present embodiment, because the bypass flow is suppressed, it is possible to improve the efficiency at which hydrogen gas is supplied from the hydrogen electrode-side porous flow field 14h to the membrane electrode assembly 21. Furthermore, in the present embodiment, the bypass flow of reactant gas is suppressed outside the hydrogen electrode-side porous flow field 14h. Thus, the present embodiment is advantageous in that there are no restrictions on the material or structure of the reactant gas flow field. For example, the aspects of the invention may be not only applied to the hydrogen electrode-side porous flow field 14h, which is a porous member, but also to a structure that uses a reactant gas flow field made of an expanded metal or a press material.

Note that the above embodiment describes the example in which the aspects of the invention are applied to both the hydrogen electrode-side flow field and the air electrode-side flow field; instead, the aspects of the invention may be applied to only one of the flow fields.

In addition, in the present embodiment, although it is not an essential requirement, the plurality of seal members 27x particularly form partial dams that are distanced from each other. Thus, it is possible to generate a contact pressure of the seal members 27x without excessively increasing a reaction force to the plate. The seal members 27x thus formed as the dams may connect the surrounding seal member 27s to the outer periphery of each of the reactant gas flow fields 14h and 14a or may have a shape by which a gap between the outer periphery of each of the reactant gas flow fields 14h and 14a and the surrounding seal member 27s is closed (or reduced) so as to facilitate a decrease in pressure of reactant gas that flows in the gap.

These various structures may be formed to reduce the bypass flow, for example, in such a manner that a pressure difference between the inlet and outlet of reactant gas in each of the reactant gas flow fields 14h and 14a, which causes the bypass flow and is due to a decrease in pressure in each of the reactant gas flow fields 14h and 14a, is reduced in step by step (or reduced in one step) by the dams.

The embodiment of the invention is described above; however, the aspects of the invention are not limited to the embodiment. The aspects of the invention may be implemented in various forms without departing from the scope of the invention. In addition, the following alternative embodiments may also be implemented, for example.

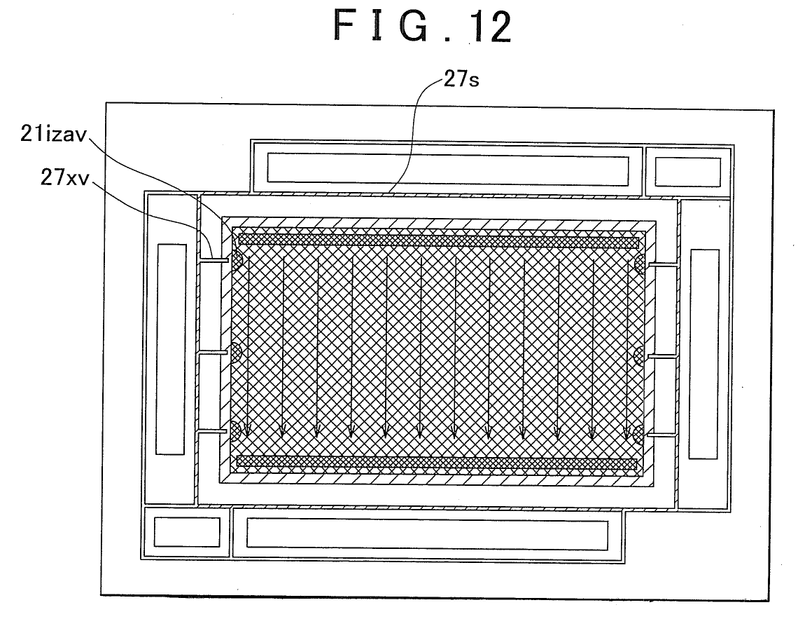

In the above embodiment, the seal members 27x extend across the outer periphery of the hydrogen electrode-side porous flow field 14h to the inside of the outer periphery. Instead, like seal members 27xv (FIG. 12) according to a first alternative embodiment, the seal members may be configured to terminate on the outer side of the outer periphery of the hydrogen electrode-side porous flow field 14h. In this alternative embodiment, contact pressure decreasing regions 21izav are further reduced. Thus, the alternative embodiment is advantageous in that it is possible to further suppress a decrease in the efficiency at which electric current is collected to the separator 40. However, the embodiment is advantageous in that it is possible to further effectively suppress the bypass flow as compared with the first alternative embodiment.

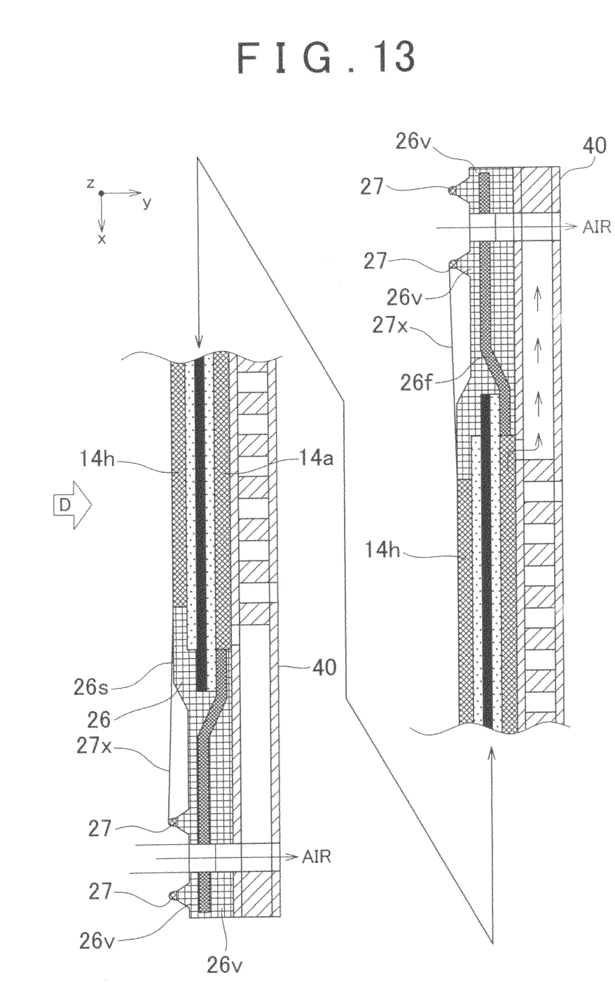

In the above described embodiment, the electric power generating element 20 is separately formed from the separator 40. Instead, the aspects of the invention may be, for example, applied as an integrated structure (FIG. 13) according to a second alternative embodiment. This structure is advantageous in that it is possible to prevent the bypass flow in the air electrode-side porous flow field 14a without decreasing the efficiency at which electric current is collected to the separator 40. In addition, this structure may be implemented by interchanging the air electrode-side porous flow field 14a and the hydrogen electrode-side porous flow field 14h.

In the above described embodiments, the solid polymer fuel cell is illustrated; however, the type of the fuel cell is not limited to the solid polymer type. The aspects of the invention may be applied to another type of fuel cell, such as a solid oxide fuel cell, a molten carbonate fuel cell, and a phosphoric acid fuel cell.

In the above described embodiments, the bypass flow is suppressed by the linear seal members. Instead of the linear seal members, various structures may be employed, such as a structure using a spongy member or a structure that a linear seal member made of fluid having a predetermined viscosity (for example, liquid seal) is applied to the recess 26r and deposited at the downstream side of the hydrogen electrode-side porous flow field 14h or air electrode-side porous flow field 14a. It is only necessary that the typical bypass flow suppressing portion according to the aspects of the invention suppresses the bypass flow in the flow of reactant gas between the outer periphery of the reactant gas flow field and the surrounding seal member.

Note that the aspects of the invention may be implemented in a fuel cell, a method of manufacturing a fuel cell stack, a fuel cell system, a fuel cell vehicle, a membrane electrode assembly, and other various forms.

While some embodiments of the invention have been illustrated above, it is to be understood that the invention is not limited to details of the illustrated embodiments, but may be embodied with various changes, modifications or improvements, which may occur to those skilled in the art, without departing from the spirit and scope of the invention.

What is claimed is:

1. An electric power generating element that generates electric power using reactant gas supplied thereto, comprising:
an electrolyte portion;
a reactant gas flow field that supplies the reactant gas to the electrolyte portion;
a surrounding seal member that surrounds an outer periphery of the reactant gas flow field; and
a bypass flow suppressing portion that suppresses a bypass flow, which is a flow of the reactant gas between the outer periphery of the reactant gas flow field and the surrounding seal member.

2. The electric power generating element according to claim 1, wherein the bypass flow suppressing portion has a linear seal member that extends from the surrounding seal member toward the outer periphery of the reactant gas flow field.

3. The electric power generating element according to claim 2, wherein the linear seal member extends from the surrounding seal member across the outer periphery of the reactant gas flow field to an inside of the outer periphery.

4. The electric power generating element according to claim 2, wherein a squeeze of the linear seal member is smaller than or equal to a squeeze of the surrounding seal member.

5. The electric power generating element according to claim 4, wherein the linear seal member has a shape such that a squeeze adjacent to the reactant gas flow field is smaller than a squeeze adjacent to the surrounding seal member.

6. The electric power generating element according to claim 5, wherein the linear seal member has a shape such that a squeeze of the linear seal member is continuously reduced from a side adjacent to the surrounding seal member toward a side adjacent to the reactant gas flow field.

7. The electric power generating element according to claim 2, wherein the linear seal member is arranged between a region, in which the reactant gas flow field is supplied with the reactant gas, and a region, in which the reactant gas flow field discharges the reactant gas, in a direction in which the reactant gas flows in the reactant gas flow field.

8. The electric power generating element according to claim 2, wherein a plurality of the linear seal members are provided.

9. The electric power generating element according to claim 2, wherein the linear seal member connects the surrounding seal member to the outer periphery of the reactant gas flow field.

10. The electric power generating element according to claim 2, wherein the linear seal member has a shape by which a gap between the outer periphery of the reactant gas flow field and the surrounding seal member is closed or reduced so as to facilitate a decrease in pressure of the reactant gas that flows between the outer periphery of the reactant gas flow field and the surrounding seal member.

11. The electric power generating element according to claim 4, wherein
the surrounding seal member intersects with the linear seal member at an intersection, and
at the intersection, the squeeze of the surrounding seal member is equal to the squeeze of the linear seal member.

12. The electric power generating element according to claim 2, wherein the linear seal member has a straight line shape.

13. The electric power generating element according to claim 4, wherein a direction in which the linear seal member extends from the surrounding seal member toward the outer periphery of the reactant gas flow field intersects with a direction in which the reactant gas flows in the reactant gas flow field.

14. The electric power generating element according to claim 1, wherein the bypass flow is a flow of the reactant gas other than the reactant gas that flows within the reactant gas flow field.

15. A fuel cell unit comprising:
the electric power generating element according to claim 1; and
a separator that is connected to the electric power generating element and that has a channel through which the reactant gas is supplied to the electric power generating element.

16. A fuel cell stack comprising:
the electric power generating element according to claim 1; and
a separator that has a channel through which the reactant gas is supplied to the electric power generating element, wherein
the electric power generating element and the separator are alternately stacked.

17. The fuel cell stack according to claim 16, wherein the electric power generating element and the separator are integrated.

18. A fuel cell stack comprising:
the electric power generating element according to claim 8; and
a separator have a channel through which the reactant gas is supplied to the electric power generating element, wherein:
the electric power generating element and the separator are alternately stacked; and
the plurality of the linear seal members are provided on both sides of the electric power generating element respectively and arranged so as to overlap as viewed in a direction in which the electric power generating element and the separator are stacked with respect to one another.

19. A fuel cell stack comprising:
the electric power generating element according to claim 4; and
a separator that has a channel through which the reactant gas is supplied to the electric power generating element, wherein
the electric power generating element and the separator are alternately stacked, and the squeeze of the linear seal member and the squeeze of the surrounding seal member are measured in a direction in which the electric power generating element and the separator are stacked.
